(19) United States
(12) Patent Application Publication
(10) Pub. No.: US 2025/0349205 A1
(43) Pub. Date: Nov. 13, 2025

(54) WEARABLE DEVICE FOR MONITORING WORKERS' SAFETY IN THE HYDROCARBON INDUSTRY

(71) Applicant: SAUDI ARABIAN OIL COMPANY, Dhahran (SA)

(72) Inventors: Majid A. ALAMOUDI, Dhahran (SA); Nawaf S. ALTAHINI, Dhahran (SA); Saleh A. ALMUFADHI, Dhahran (SA)

(73) Assignee: SAUDI ARABIAN OIL COMPANY, Dhahran (SA)

(21) Appl. No.: 18/661,214

(22) Filed: May 10, 2024

(51) Int. Cl. G08B 25/01; G06V 40/10; G08B 7/06; G08B 21/14; G08B 25/10; H04W 4/021; H04W 4/029; H04W 4/80; H04W 4/90

(52) U.S. Cl. CPC G08B 25/016; G06V 40/10; G08B 7/06; G08B 21/14; G08B 25/10; H04W 4/021; H04W 4/029; H04W 4/80; H04W 4/90

(57) ABSTRACT

A wearable device is disclosed herein for monitoring worker safety in a hydrocarbon industry, including personal protection equipment compliance using a computer vision algorithm. The wearable device is worn by a user, such as a worker, in a geographical area that includes a work area. The wearable device is configured to capture physiological measurements from the user and a location of the wearable device that is representative of a location of the user. A work area safety analysis tool implemented on a remote computing platform can receive the physiological measurements and the location. The work area safety analysis tool can evaluate the physiological measurements and the location to assess potential health and/or safety risks to the user with respect to the work area. An alert generated by the work area safety analysis tool can be received by the wearable device to notify the user of potential health and/or safety risks.

### FIELD OF THE DISCLOSURE

This disclosure relates generally to a hydrocarbon industry, and more specifically, to a wearable device for monitoring a safety of a user, such as work, for example, in an oil and/or gas industry.

### BACKGROUND OF THE DISCLOSURE

The hydrocarbon industry, encompassing exploration, extraction, refining, and transportation of oil and gas, is inherently associated with occupational hazards. Ensuring workplace safety within this sector is important due to high-risk environments that workers are exposed to daily, which can lead to injuries and death. Some common work hazards or risks to workers in a hydrocarbon industry include falls, hazardous areas, confined spaces, machine hazards, explosions and fires, and physical strain.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a system can include a wearable device worn by a user in a geographical area that includes a work area. The wearable device is configured to capture physiological measurements from the user and a location of the wearable device that is representative of a location of the user. The system further includes a work area safety analysis tool to evaluate the captured physiological measurements and the location to assess potential health and/or safety risks to the user with respect to the work area.

According to another embodiment, a system can include a wearable device that is configurable to be worn by a worker in an industrial or construction work area. The wearable device can include cameras to capture one or more images of the users, physiological sensors to capture physiological measurements of the user, a location component to determine a location of the wearable device that is representative of a location of the user, a communication component to transmit over a wireless network the physiological measurements of the user, and the location of the wearable device to a work area safety analysis tool on a remote computing platform, memory to store machine-readable instructions, and one or more processors to access the memory and execute the machine-readable instructions to receive an alert indicating that a health and/or safety of the user is potentially at risk. The alert can be generated by the work area safety analysis tool in response to determining that a health and/or safety of the user is potentially at risk with respect to the industrial or construction work area based on the capture physiological measurements and the location of the wearable device.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a block diagram of a system with a wearable device for improving workplace safety in a hydrocarbon industry.

FIG. 2 is a simplified example of a functionality map of the system, as shown in FIG. 1.

FIG. 3 is a block diagram of a wearable device.

FIG. 4 is an example of a radio-frequency (RF) front end of a Global Navigation Satellite System (GNSS) receiver of the wearable device.

FIG. 5 is a simplified example of a functionality map of the wearable device.

FIG. 6 is an example of a circuit representative of a pulse oximeter of the wearable device.

FIG. 7 is an example of a circuit representative of a temperature sensor of a wearable device.

FIG. 8 is an example of a work permit issuer (WPI) using a graphical user interface (GUI) provided by a work area safety analysis tool.

FIG. 9 is an example of workers using the wearable device around a wrist.

FIG. 10 is an example of the wearable device of one of the workers in FIG. 9 before receiving an alert from a tool.

FIG. 11 is an example of the wearable device of one of the workers in response to receiving the alert from the work area safety tool.

FIG. 12 is an example of a table identifying thresholds for use by the work area safety analysis tool for monitoring a safety and/or health of a user (or worker).

FIG. 13 is an example of a method for notifying the user using the wearable device that the user has an elevated body temperature.

FIG. 14 is an example of a method for notifying the user using the wearable device that the user has an elevated heart rate.

FIG. 15 is an example of a method for notifying the user using the wearable device that the user is at risk for heat stroke.

FIG. 16 is an example of a method for notifying the user using the wearable device of elevated concentration of hydrogen sulfide (H₂S) gas.

FIG. 17 is an example of a method for notifying the user using the wearable device that the user is not complying with personal protective equipment (PPE) practices and/or rules.

FIG. 18 is a block diagram of a system that can be used to perform one or more methods according to an aspect of the present disclosure.

FIG. 19 is an example of a cloud computing environment that can be used to perform one or more methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Statistics showed that many workers (sometimes referred to as contractors) get themselves injured when working at construction job sites that are not familiar with, as many of them are not restricted to stay in their specific working location in the field as assigned by a work permit issuer (WPI), or by simply not complying with personal protective equipment (PPE) rules. Also, workers often work in adverse environmental conditions which make workers vulnerable to heat strokes. According to an International Association of Oil & Gas Producers, a number of contractor fatalities and injuries recorded in 2021 are 18 and 19,975, respectively. Based on the Health and Safety Executive UK Government Agency's Cost Benefit Analysis, the estimated losses due to fatalities and incidents recorded in 2021 are $38.4 million and $1.14 billion, respectively. Thus, a need exists for reducing a loss or harm to life of contractors at facilities. Examples are disclosed herein relating to configuring users (e.g., contractors, or other personnel) at a worksite with a wearable device. The wearable device can be used to mitigate accidents, reduce fatalities, and enhance workplace safety standards globally.

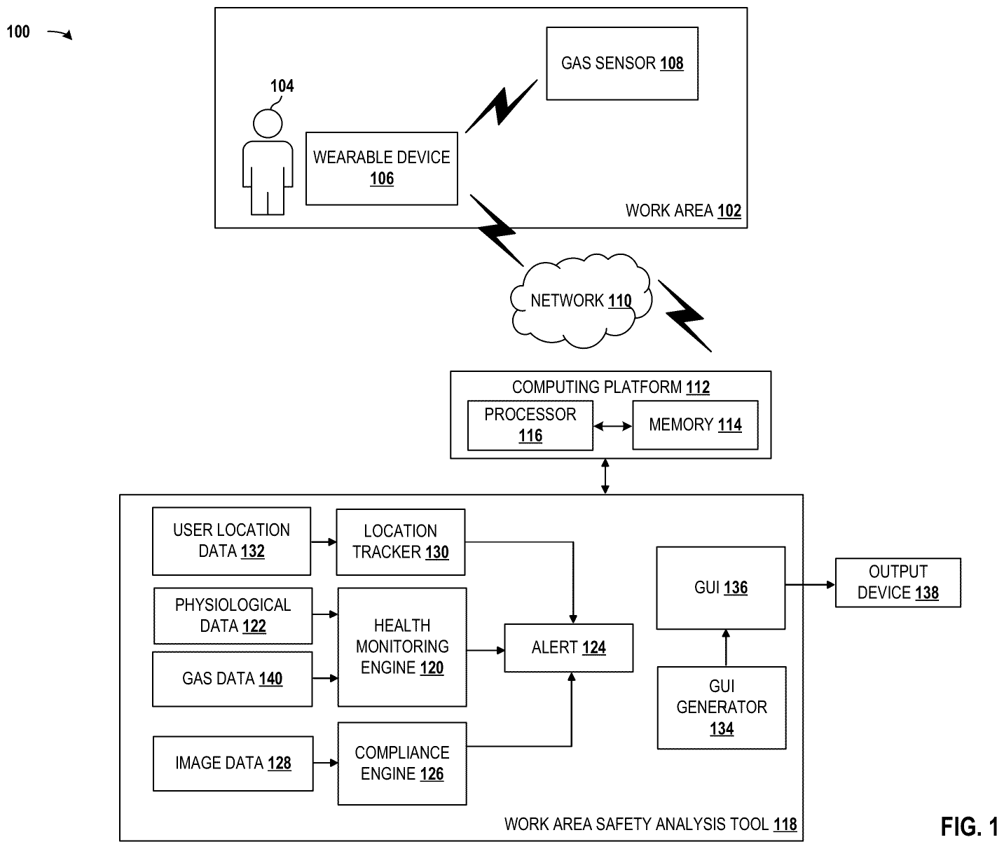

FIG. 1 is an example of a block diagram of a system 100 with a wearable device 106 for improving workplace safety in a hydrocarbon industry, such as an oil and/or gas industry. A user 104 can be equipped with the wearable device 106. In some examples, the wearable device 106 is a wrist type of wearable device, and can be referred to as a wristband. The user 104 can carry/wear the wearable device 106 in a geographical area that includes a work area 102. The work area 102 can be a work area for the user 104 at a hydrocarbon facility, site, or plant. The wearable device 106 can provide real-time 3D location tracking, continuous monitoring of vital signs, and can be used to ensure personal protective equipment (PPE) compliance. In some examples, the user 104 is a construction worker or an industrial worker, but other users of the wearable device 106 are contemplated within the scope of this disclosure. The wearable device 106 can provide various types of data as disclosed herein over a network 110 to a work area safety analysis tool 118, as shown in FIG. 1, which can be referred to herein as the tool 118. The tool 118 and the wearable device 106 can be implemented as part of Supervisory Control and Data Acquisition (SCADA) system, which is an architecture of a control system that can include computer devices, network data communications and a graphical user interface (GUI) that analyzes data collected from sensors of processes or machineries, and allows for control of such processes or machineries. For the system 100, the tool 118 can collect the data from various sensors in the wearable device 106, analyze the data and display desired information through a computer device and GUI 136, and allows for controls of alerts displayed in both wearable device 106 and the GUI 136 of the tool 118.

The tool 118 can analyze the data to determine whether a safety of the user 104 is at risk. The network 110 can include wireless and/or wired technologies. In some examples, the network 110 includes a cellular network (e.g., a telecommunication network) configured to support Long-Term Evolution for machine (LTE-M). Thus, in some instances, the wearable device 106 can be configured to support local power wide area network (LPAN) communication technologies. The network 110 can be used to enable the wearable device 106 configured as an LTE-M type of device to transmit the data, such as disclosed herein, to another LTE-M type device, which can be used for implementing the tool 118. The wearable device 106 can be configured with a subscriber identity card (SIM) Card or embedded subscriber identity (eSIM) for communication through telecommunication/cell towers (the network 110) in some implementations.

The tool 118 can be implemented using one or more modules, shown in block form in the drawings. The one or more modules can be in software or hardware form, or a combination thereof. In some examples, the tool 118 can be implemented as machine readable instructions for execution on a computing platform 112, as shown in FIG. 1. The computing platform 112 can include one or more computing devices selected from, for example, a desktop computer, a server, a controller, a blade, a mobile phone, a tablet, a laptop, a personal digital assistant (PDA), and the like.

The computing platform 112 can include a processor 116 and a memory 114. By way of example, the memory 114 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 116 can be implemented, for example, as one or more processor cores. The memory 114 can store machine-readable instructions (e.g., the tool 118) that can be retrieved and executed by the processor 116. Each of the processor 116 and the memory 114 can be implemented on a similar or a different computing platform. The computing platform 112 can be implemented in a cloud computing environment (for example, as disclosed herein) and thus on a cloud infrastructure. In such a situation, features of the computing platform 112 can be representative of a single instance of hardware or multiple instances of hardware executing across the multiple of instances (e.g., distributed) of hardware (e.g., computers, routers, memory, processors, or a combination thereof). Alternatively, the computing platform 112 can be implemented on a single dedicated server or workstation. In some examples, the tool 118 can be implemented as part of or integrated into an application, but in other instances, can be implemented as a stand-alone application/software (e.g., and can be invoked by software, a program, a routine, in other instances, invoked by a user). In some examples, the computing platform 112 is a computing device. The computer device can be a personal computer with a monitor display or a tablet in which the tool 118 can be implemented on an operating system, and a user (e.g., a WPI) can interact with the tool 118 through a graphical user interface (GUI).

For example, the wearable device 106 can be configured with a position sensor to provide accurate and real-time tracking of the user 104, for example, within the work area 102 (also can be referred to as a jobsite). The wearable device 106 can provide user location data 132 indicative of a position or location of the user 104 in the work area 102. The user location data 132 can be transmitted by the wearable device 106 over the network 110 to the tool 118 for further processing. The tool 118 can include a location tracker 130. The location tracker 130 can evaluate the user location data 132 t0 determine whether the user 104 is an approved area within the work area 102. For example, the location tracker 130 can compare the position data to a work site map (or geofence) to determine whether the user 104 is the approved area. The location tracker 130 can evaluate the location of the user 104 relative to a geofence representative of a virtual perimeter of the work area 102 to determine whether the user is outside of the work area 102.

The location tracker 130 can issue an alert 124 in response to determining that the user 104 is outside of the work area 102. The alert 124 can indicate that a health and/or safety of the user 104 is potentially at risk. The tool 118 can communicate the alert 124 to the wearable device 106 to notify the user 104 that the user is not in the work area 102 (or a specified portion of the work area 102) that has been approved for the user 104, or is in a hazardous area. Thus, the wearable device 106 can be used to reduce a risk of an accident from the user 104 straying into unfamiliar or hazardous areas.

In some examples, the GUI 136 can be provided based on the alert 124 to notify a WPI that a health and/or safety of the user 104 is at risk with respect to the work area 102. The WPI can use the alert 124 to take proactive measures and control equipment 142 in the working area 102 through a control system. For example, the tool 118 can issue a control command 144 (based on user input from the WPI) to change an operating state (condition) of the equipment 142, such as configure the equipment 142 to operate in a reduced state or an off-state. The control command 144 can be provided over the network 110 to which the equipment 102 can be connected. In some examples, the tool 118 can automatically issue the control command 144 without user input from the WPI. The tool 118 can control any number of different equipment in the work area 102, including similar and different equipment. In yet other examples, the control command 144 specifying the operating condition for the equipment 142 can be provided to the wearable device 106 through which the equipment 142 can be controlled.

In some examples, the wearable device 106 includes a body temperature sensor and an oxygen sensor, such as a pulse oximeter. The body temperature sensor can be used to measure a skin temperature of the user 104 and the wearable device 106 can provide body temperature measurements. The oxygen sensor can be used to measure an oxygen level of the user 104 to provide oxygen level measurements. In some examples, the oxygen sensor can be used to measure a heart rate of the user 104. The measured skin temperature, the body temperature measurements, and the measured heart rate of the user 104 can be provided over the network 110 to the tool 118, which can be stored in the memory 114 as physiological data 122, as shown in FIG. 1. By analyzing the physiological data 122, the tool 118 can predict and prevent heat strokes and other health-related incidents, particularly crucial for users exposed to extreme temperatures. For example, the tool 118 includes a health monitoring engine 120. The health monitoring engine 120 can analyze the physiological data 122 according to one or more examples, as disclosed herein, to provide the alert 124. The alert 124 can be provided over the network 110 to the wearable device 106 to notify the user of potential health risks. In some examples, the health monitoring engine 120 can predict whether the user 104 is at risk for heat stroke, as well as other health related risks, and monitor vital signs of the user 104.

In some examples, the wearable device 106 can communicate with a gas sensor 108. In some examples, the gas sensor 108 includes a hydrogen sulfide (H₂S) gas detector. The gas sensor 108 can be used to measure a concentration of a harmful (or toxic) gas to the user 104 at the work area 102. The gas sensor 108 can be located at the work area 102, or a number of gas sensors (similar or a combination of different gas sensors, such as disclosed herein, can be located throughout the work area 102). Example harmful gasses can include, but are not limited to, carbon monoxide, cardio dioxide, ammonia, chlorine, sulfur dioxide, ozone, etc. The gas sensor 108 can be configured with a Bluetooth technology to provide real-time gas concentration levels corresponding to gas data 140 through the wearable device 106 to the tool 118 for processing therein. In some examples, the health monitoring engine 120 can issue the alert 124 based on the gas data 140 according to one or more examples herein, for example, when H₂S gas is an elevated level (or dangerous level). In additional or alternative examples, the gas data 140 can be provided to a GUI generator 134 to provide a GUI 136 with a graph of the gas concentration (e.g., H₂S levels). The GUI 136 can be rendered on an output device 138. The output device 138 can be a display, as a non-limiting example.

In some examples, the wearable device 106 can include one or more cameras. The one or more cameras can be wide view cameras, such as 11 millimeter (mm) wide view cameras and allow for more than 120 degrees of field of view (FOV). The one or more cameras can capture images of the user 104 to provide image data 128, which can be transmitted over the network 110 to tool 118. For example, the wearable device 106 can periodically provide the image data 128. The tool 118 can include a compliance engine 126. The compliance engine 126 can use one or more computer vision algorithms to analyze the one or more images to determine whether the user 104 is PPE compliant. For example, the tool 118 can periodically evaluate the image data 128 to determine whether the user 104 is PPE compliant. If the user 104 is not PPE compliant, the compliance engine 126 can output the alert 124, which can be provided over the network 110 to the wearable device 106 to notify the user 104 that the user 104 is not PPE compliant.

A user of the tool 118, which can be referred to as a tool user herein, can utilize the tool 118 to monitor a well-being and a location of the user 104 through a user-friendly interface (the GUI 136) and receive alerts when violations occur, such as location or PPE violations. Example tool users can include a work permit issuer. Thus, the tool 118 can be used to enable WPI to define designated work areas and boundaries through a monitoring dashboard (the GUI 136). One or more violations can trigger immediate safety measures, including alerts to WPI workers, and automatic reporting to a Safety Management System (SMS). The wearable device 106 can be used to mitigate accidents, reduce fatalities, and enhance workplace safety standards globally.

Accordingly, the wearable device 106 and the tool 118 can be used in cooperation to monitor a safety of the user 104 at the work area 102. The tool 118 can be used for PPE detection through computer vision, H₂S detection, heat stroke prediction, vital sign monitoring, location monitoring (e.g., 3D location monitoring), and alert personnel.

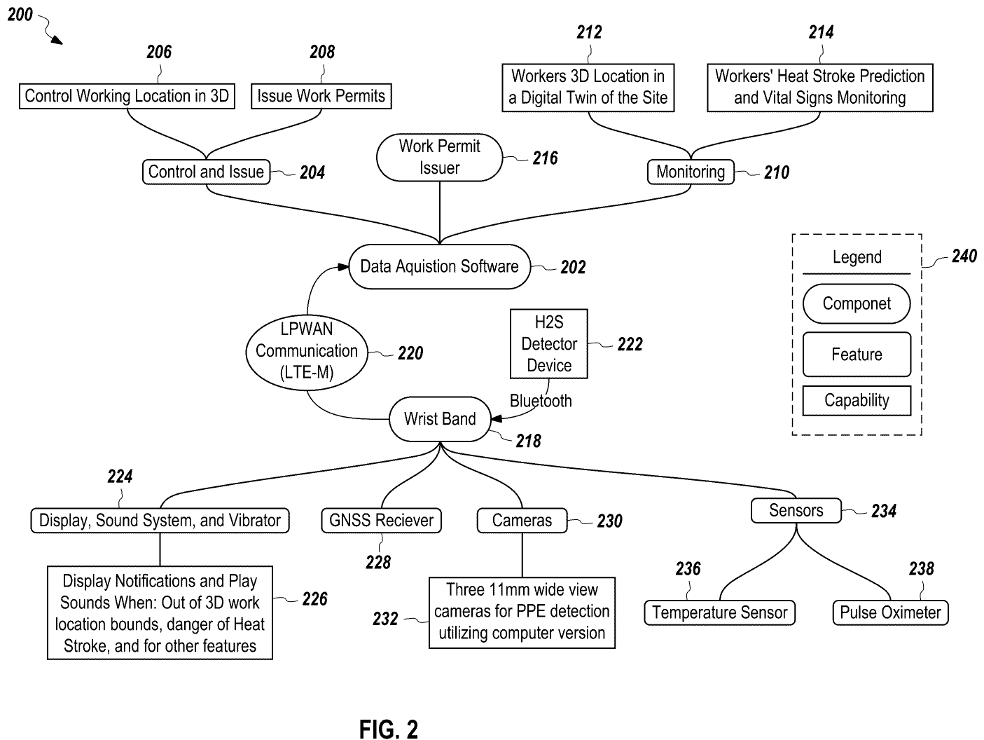

FIG. 2 is a simplified example of a functionality map 200 of the system 100. Thus, reference can be made to one or more examples of FIG. 1 in the example of FIG. 2. The functionality map includes a legend 240, which identifies components, features, and a capability of the system 100. The functionality map 200 includes data acquisition software 202 corresponding to the tool 118, as shown in FIG. 1 The data acquisition software 202 can be used, at 204, to control a working location 206 of the user 104 (e.g., specify which areas on the work area 102 that the user is permitted to visit or use) and issue work permits 208. The data acquisition software 202 can also be used, at 210, to monitor the 3D location of the user 104 at 212, such as in a digital twin (e.g., digital representation) of the work area 102. At 214, the user 104 can be monitored for heat stroke and vital signs can be observed as well. A work permit issuer, at 216, according to one or more examples, as disclosed herein, can interact with the data acquisition software 202. The data acquisition software 202 can communicate with a wristband 218 over a network 220 (e.g., the network 110, as shown in FIG. 1). The wristband 218 can correspond to wearable device 106, as shown in FIG. 1. The data acquisition software 202 can process data from the wristband 218 by a computer/tablet's Central Processing Unit (CPU) (e.g., the processor 116, as shown in FIG. 1). The CPU can be programmed to manipulate the data and perform calculations. The data can be used for monitoring and control capabilities accessed through the GUI 136, as shown in FIG. 1, by the WPI. There can be several sources of data, which can be categorized into two data pools, Global Navigation Satellite System (GNSS) data and sensor data. The GNSS data can be processed by a GNSS receiver, which can correspond to the location tracker 130, as shown in FIG. 1. The sensor data can be used for monitoring in the GUI, notify the user 104 of the wristband 218 via sound, vibration and/or screen system, and notify a WPI through the GUI (or at a device of the WPI).

For example, the GUI 136 of the data acquisition software 202 can allow the WPI to control a work location, which is a location area in which the wristband 218 is allowed to be inside. The boundaries of such locations can be pre-specified in the data acquisition software 202 for each work area 102 (e.g., plant), and the WPI can select by the GUI 136 a work location where the wristband 218 can stay in without notifying the user 104. In some examples, the WPI can manually specify a work location for exceptional cases. Also, the WPI can specify which PPE can be required for work activity to be monitored by the wristband 218. The data acquisition software 202 can allow the WPI to control basic intuitive functions such as activating and deactivating the wristband 218, and assigning wristbands to users/workers.

For example, the data acquisition software 202 can provide through the GUI 136 to the WPI the following live data collected by the wristband 218: 3D location, PPE compliance, body temperature, heart rate, oxygen level, and H₂S levels captured by an H₂S sensor. In addition, the data acquisition software 202 can have a digital representation of the work area 102, in which the 3D location is displayed for accurate visualization of the wristband 218 for the WPI. The data acquisition software 202 can notify the WPI and the wristband 218 for one or more of the following events: the wristband 218 is out of bounds, elevated body temperature level, elevated heart rate, risk of heat stroke, elevated H₂S levels, PPE non compliance, and reduced oxygen levels.

For example, the network 220 can support LPWAN communication (e.g., LTE-M type of communications). The wristband 218 can also communicate via Bluetooth with an H₂S detector device 222, which can correspond to the gas sensor 108, as shown in FIG. 1. The wristband 218 can include display, sound system, and vibrator 224. At 226, the display can be used to provide notifications (e.g., the alert 124, as shown in FIG. 1) and in some instances play one or more sounds based on the alert 124, such as when out of 3D location bounds, danger of heat stroke and/or for other health and non-health related features (or reasons). The wristband 218 can also include a Global Navigation Satellite System (GNSS) receiver 228, which can be used to provide data indicative of a location of the wristband 218 and thus the user 104 of the wristband 218. The wristband 218 can include cameras 230, which can be used, at 232, for example for PPE detection. The wristband 218 can include sensors 234, such as a temperature sensor and a pulse oximeter, as disclosed herein, for monitoring and/or recording vitals signs of the user 104.

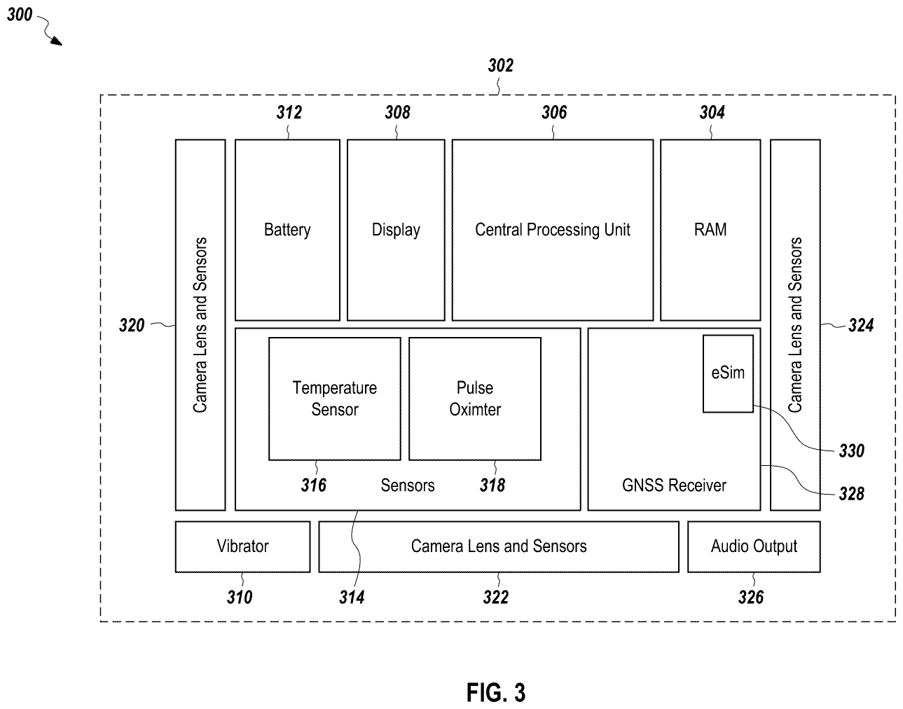

FIG. 3 is a block diagram of a wearable device 106, as shown in FIG. 1. Thus, reference can be made to one or more examples of FIGS. 1-2 in the example of FIG. 3. The wearable device 106 can include a body or case 302 that contains components of the wearable device 106. The components can include random access memory (RAM) 304 and a CPU 306. The CPU 306 can access the RAM 304 to execute machine readable instructions for operating the wearable device 106. For example, the machine readable instructions can control a display 308 of the wearable device 106, communication with (e.g., to and from) the tool 118, the gas sensor 108, and other functions of the wearable device 106. For example, the machine readable instructions can process the alert 124 from the tool 118 to notify the user 104 (e.g., when the user 104 is outside of a permitted area, potential health risk, etc.) via the display 308. In some examples, the alert 124 can be used to control a vibrator 310 to notify the user 104 through vibration of the wearable device 106. In some examples, the machine readable instructions can control a speaker 326 of the wearable device 106 to provide an audible notification to the user 104 based on the alert 124. The wearable device 106 can include a battery 312 for powering one or more components of the wearable device 106. The wearable device also includes sensors 314, including a temperature sensor 316 to provide body surface temperature measurements of the user 104, and a pulse oximeter 318 to provide oxygen and heart rate levels (measurements). The wearable device 106 includes a first, second, and third wide view cameras 320-324 (e.g., an 11 millimeter (mm) wide view camera). The cameras 320-324 can be used to provide one or more images, which can be analyzed by the tool 118 to determine whether the user 104 is PPE compliant.

The wearable device 106 can include a GNSS receiver 328. The GNSS receiver 328 calculates a geographical position by utilizing GNSS. The GNSS receiver 328 can communicate with the GNSS by receiving RF signals from GNSS and performs signal processing and calculations, which can be hardware and/or software based. For example, a software based GNSS receiver can be used since such a receiver is more compact and financially less costly than a hardware based GNSS receiver. The GNSS receiver 328 can receive, and process RF signals communicated with GNSS, and output a location of the wearable device 106.

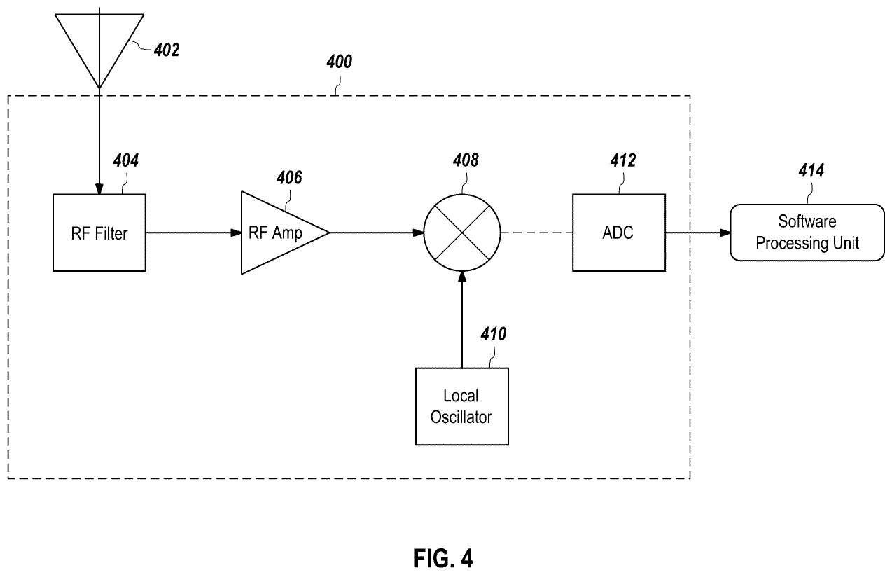

FIG. 4 is an example of a radio-frequency (RF) front end 400 of the GNSS receiver 328 that can be used to receive an RF signal from the GNSS. Thus, reference can be made to one or more examples of FIGS. 1-3 in the example of FIG. 4. The GNSS receiver 328 can include antenna 402. The antenna 402 is a component that is able to receive electromagnetic waves (RF signals), and transforms the RF signal into an electrical signal, referred to as a GNSS signal(s). After the RF signal is captured by the antenna 402, the RF front end 400 prepares the GNSS signal to be processed through multiple stages. Example RF architectures that can be used for implementing RF front end processing at the RF front end 400 can include, but not limited to, Heterodyne, Low-IF and Zero-IF.

For example, the RF front end 400 includes an RF filter 404 to filter the GNSS signal to remove any noise and/or reject any interface, and an RF amplifier 406 to amplify the filtered GNSS signal. Then, the amplified GNSS signal is converted to an intermediate frequency (IF) through a process called Heterodyning, which can use a mixer 408 and a local oscillator 410, to provide a converted GNSS signal. Then, the converted GNSS signal can be provided to an analog-to-digital (ADC) converter 412 to digitize the converted GNSS signal to provide a digitized GNSS signal. The digitized GNSS can be used by a software processing unit 414 of the GNSS receiver 328 for determining a location of the wearable device 106. The software processing unit 414 can analyze a received distance, velocity and time data to determine the location of the wearable device 106. The location can be a coordinate location of the wearable device 106, which can be a three-dimensional (3D) location.

Continuing with the example of FIG. 3, the wearable device 106 can include an embedded subscriber identity (eSIM) module 330 to provide the wearable device with cellular connectivity. The eSIM module 330 can include a receiver to receive data (e.g., the alert 124, as shown in FIG. 1) and a transmitter to transmit data (e.g., physiological measurements and other data, such as the location of the wearable device 106, one or more images of the user, and gas measurements) over the network 110 with the tool 118, as shown in FIG. 1. In some examples, the wearable device 106 includes a transmitter that includes both the receiver and transmitter.

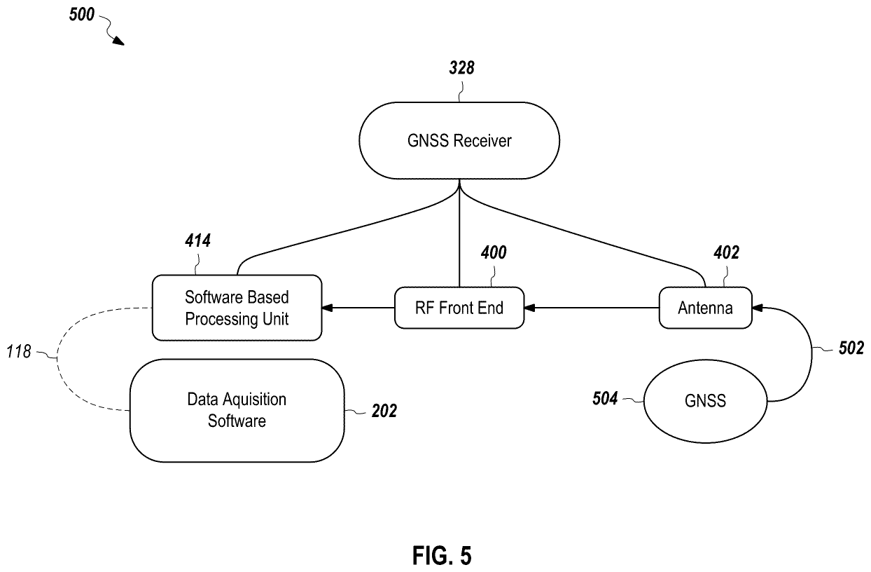

FIG. 5 is a simplified example of a functionality map 500 of the wearable device 106. Thus, reference can be made to one or more examples of FIGS. 1-4 in the example of FIG. 5. The functionality map 500 identifies a functionality or capability of GNSS receiver 328. For example, the functionality map 500 includes the GNSS receiver 328, which has the antenna 402, the RF front end 400, and the software processing unit 414. The antenna 402 can receive one or more RF signals 502 from a GNSS 504. The RF front end 400 and the software processing unit 414 can process the one or more RF signals 502 to determine the location of the wearable device 106. The software processing unit 414 or the wearable device 106 can communicate using the network 110 the user location data 132 to the data acquisition software 202 (or the tool 118).

Continuing with the example of FIG. 3, the pulse oximeter 318 can be used to measure a peripheral blood oxygen saturation (SpO2), such as at the wrist of the user 104 to determine a ratio of oxygen saturated hemoglobin to a total hemoglobin. This measurement is used to tell how well red blood cells are transporting oxygen from the lungs to other parts of the body. Normal SpO2 levels vary from 95% to 100% in a healthy adult. Levels below this range (which can define an oxygen level threshold, as disclosed herein) can indicate a condition known as hypoxemia. This means that the body of the user 104 is not transporting enough oxygen to maintain healthy organs and cognitive function. The standard for measuring oxygen saturation is atrial blood oxygenation measurement, SaO2. SpO2 is an estimate of the oxygen saturation levels measured at a periphery of the user, such as at a wrist of the user 104. The pulse oximeter 318 is part of wearable device 106 and can take the measurements from the wrist.

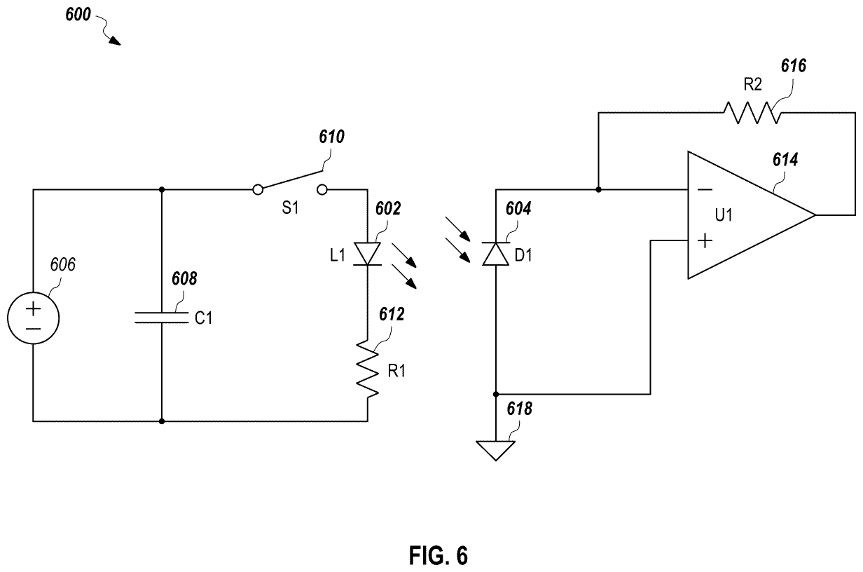

FIG. 6 is an example of a circuit 600 representative of of the pulse oximeter 318. Thus, reference can be made to one or more examples of FIGS. 1-5 in the example of FIG. 6. The circuit 600 can include two light emitting diodes (LEDs), one red 660 nanometer (nm) LED and one infrared (IR) 940 nm LED. For clarity and brevity purposes, one of the two LEDs are shown as 602 in FIG. 6, such as the red 660 nm LED. It is to be understood that that the IR 940 nm LED can be connected with respect to a photodiode (PD) 604 of the circuit 600 to allow for individual measurement of light emitted from each of the red 660 nm LED and the IR 940 nm LED, as described herein. The PD 604 can be referred to as a light detector. The PD 604 can be in a reflective or transmissive configuration. The circuit 600 includes a voltage source 606 that is connected in parallel with a capacitor 608. A switch 610 is connected between the voltage source 606 and the capacitor 608 and the LED 602, which is connected in series with a resistor 612. The LED 602 is connected between the switch 610 and a resistor 612, as shown in FIG. 6.

The switch 610 can be activated (e.g., by the CPU 306) to provide a current through the LED 602. The circuit 600 can include a second switch, which can be connected to the voltage source 606 and activated (e.g., by the CPU 306) to provide a current through a remaining LED, such as the IR 940 nm LED. The switch 610 can be activated so that the LED 602 pulses a light (e.g., red light) and the PD 604 can measure or capture the pulsed light to provide a resulting (electrical) signal. The circuit 600 includes an amplifier 614 and a resistor 616 that couples an output of the amplifier 614 to a first input of the amplifier 614 to provide a negative feedback to stabilize the resulting signal. The second input of the amplifier 614 is coupled to a ground 618, to which a first end of the PD 604 is coupled. A second end of the PD 604 is coupled to the first input of the amplifier 614. The above process at the circuit 600 can be repeated for the IR LED (the other LED) and finally with both LEDs off to get a baseline for any ambient external light sources. This generates a photoplethysmography (PPG) signal for both wavelengths. In order to construct a PPG signal, three signals are needed from three light sources: a base LED, an infrared LED, and ambient light source. The ambient light can be captured from ambient light source, which reflects ambient light. By comparing these three signals, blood levels saturated with oxygen can be identified from unsaturated blood levels. A type of oximeter configuration that can be used in the wearable device 106 is a reflective configuration since the PD 604 and the LED 602 need to be placed next to each other for practicality since the sensor will be taking measurements from the wrist. The LED's emitted light passing through a blood is captured by the PD 604 to generate the PPG signal. The reflective configuration allows for capturing the light reflecting back from the wrist.

Continuing with the example of FIG. 3, the temperature sensor 316 can be a contact temperature sensor. The temperature sensor 316 can measure a skin temperature of the user 104 and can be used to estimate a body temperature with other variables, which can be measured with infrared thermopile, thermistors, thermoelectric effects or via optical means. For example, the temperature sensor 316 can use a thermistor configuration and a resistance of the thermistor can vary depending on the (skin) temperature. Thus, the temperature sensor 316 can monitor the skin temperature from the wrist and estimate subjective thermal sensation using the monitored wrist skin temperature.

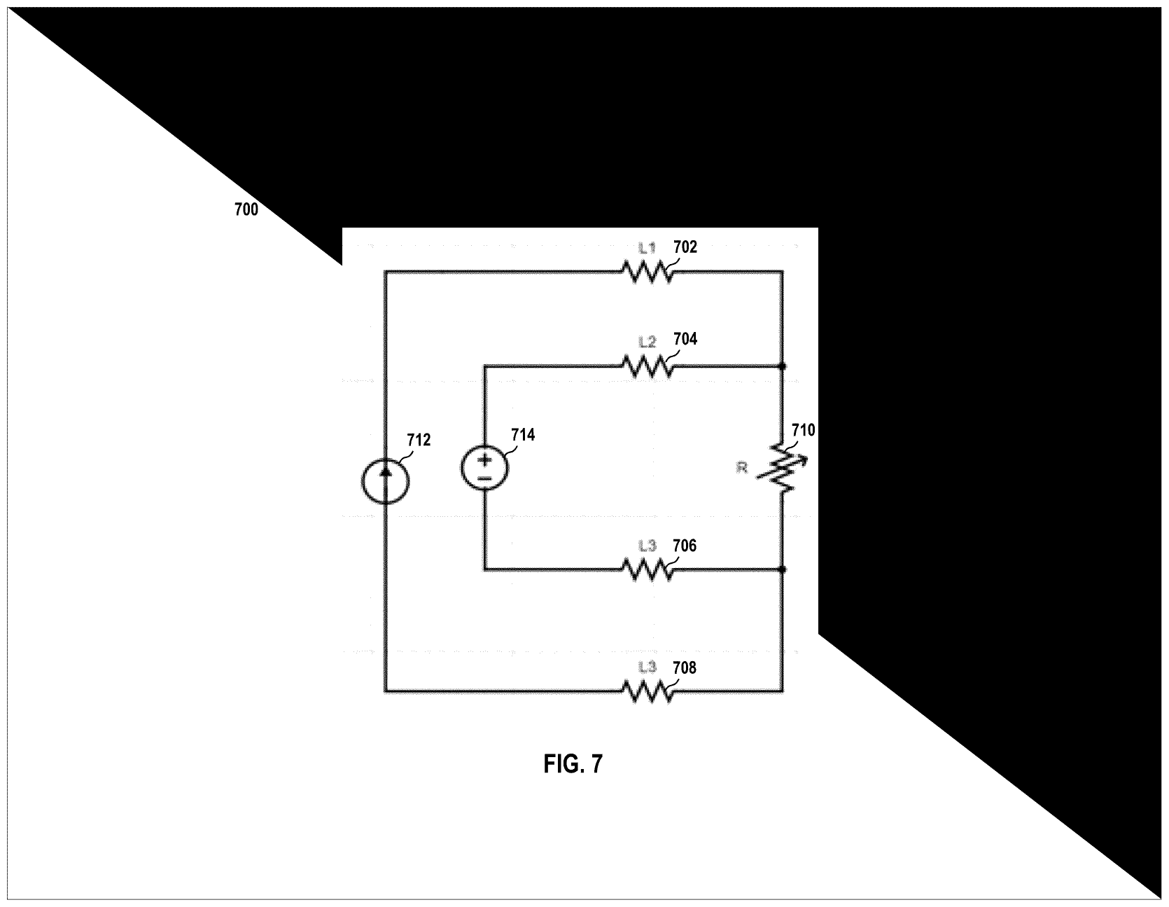

The temperature sensor 316 can include resistance thermometer (RTD) sensors. Different types of RTD sensors are categorized by a construction of a temperature sensing element. Two common types are thin film and wire wound. The type of RTD sensor that is used is determined by an environment where the RTD will be used and application. For example, the temperature sensor 316 can use thin film RTD sensors, for practicality and size. Thin film RTD elements have a thin layer of metal placed on a substrate of a ceramic material. The film of metal is etched into an electrical circuit pattern that offers a necessary amount of resistance. Thin film RTD sensors are rugged, reliable, and resistant to shock and vibration damage. Since such sensors are generally flat, thin film RTD sensors can be engineered to several applications and come in an assortment of resistance types, tolerances, sizes, and/or shapes. The etched circuit has many configurations with varying accuracies. In some examples, the etched circuit includes a 4-wire configuration, as shown in FIG. 7. FIG. 7 is an example of a circuit 700 representative of a 4-wire configuration corresponding to the temperature sensor 316 that includes resistors 702-708, a variable resistor 710, a current source 712. The resistors 702-708 correspond to wire resistance. The variable resistor 710 corresponds to an RTD element whose resistance is affected by temperature. The current source 712 can be established to maintain a constant current through the wires so that an error due to wire resistance can be minimized or eliminated. A voltmeter 714 can be used to measure a voltage across the variable resistor 710 and thus a resistance of the variable resistor 710 (e.g., the RTD element) can be determined based on Ohm's law.

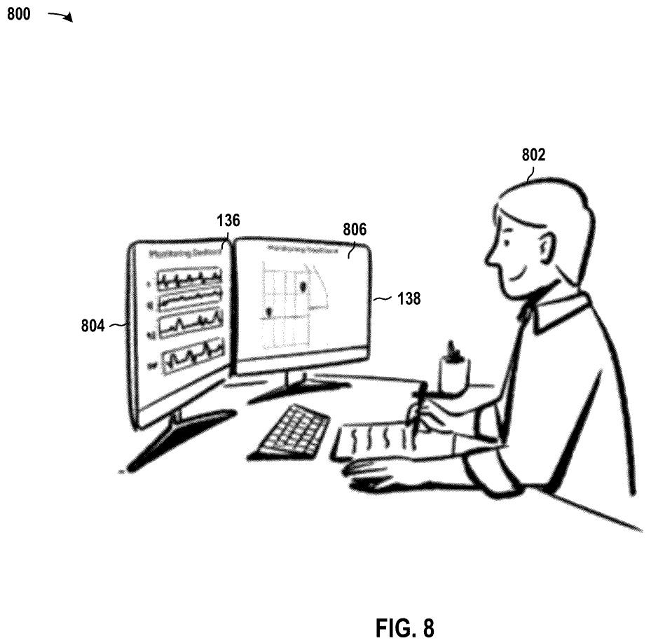

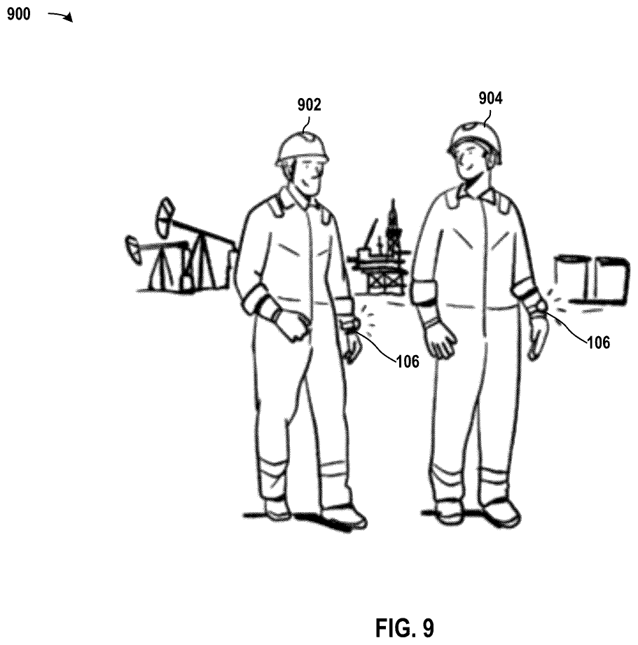

FIG. 8 is an example of a WPI 802 using the GUI 136 of the tool 118, as shown in FIG. 1. Thus, reference can be made to one or more examples of FIG. 7 in the example of FIG. 8. As shown in the example of FIG. 8, the GUI 136 can be rendered on the output device 138. The GUI 136 can include screens 804-806. For example, the screen 804 can display vital and/or gas related measurement data and graphs, and the screen 806 can display a location of the wearable device 106 relative to a digital representation of the work area 102, as shown in FIG. 1. The WPI 802 can use the GUI 136 to issue work permits to workers, enter worker personal data into the tool 118, control and monitor workers work location and safety. By way of example, workers 902-904, as shown in FIG. 9, alongside with an assigned work permit receiver (WPR) enter a facility (the work area 102) and approach the WPI from an operation site to explain planned activities at a job site. The WPR is a person responsible for completing and signing a work permit (WP) before the WPI approves the WP. The WPR can supervise conducted work in the work area 102. The WPI checks for PPE compliance of provided safety related documentation and the workers 902-904 readiness to execute the work safely. Moreover, the WPI, utilizing the GUI 136, can enter a work activity including: start and completion time alongside a work location and its bounds, and enter worker personal details such as names and ages for safety and monitoring purposes. The tool 118 can associate the inputted data with a specified wearable device number. Then, a work permit (WP) can be issued by the WPI to the WPR allowing the workers 902-904 to execute the planned activities at the job site while the WPI is monitoring their location and safety through the GUI 136 in the tool 118. While monitoring the workers 902-904, the WPI can receive an alert (e.g., the alert 124, as shown in FIG. 1) that the workers 902-904 are out of bounds, and/or that a body temperature of workers 902-904 is elevated. This has also notified the workers 902-904 through the wearable device 106 and suggested to take a break. In some examples, the workers 902-904 can return back to a working location and have a water break to cool down then continue working. Upon completion of the work or closing time of a work project (WP), the WPR can instruct the workers 902-904 to exit the site and approach the WPI to close the WP, and the WPI can reset the wearable device stored information to be used again for future WPs.

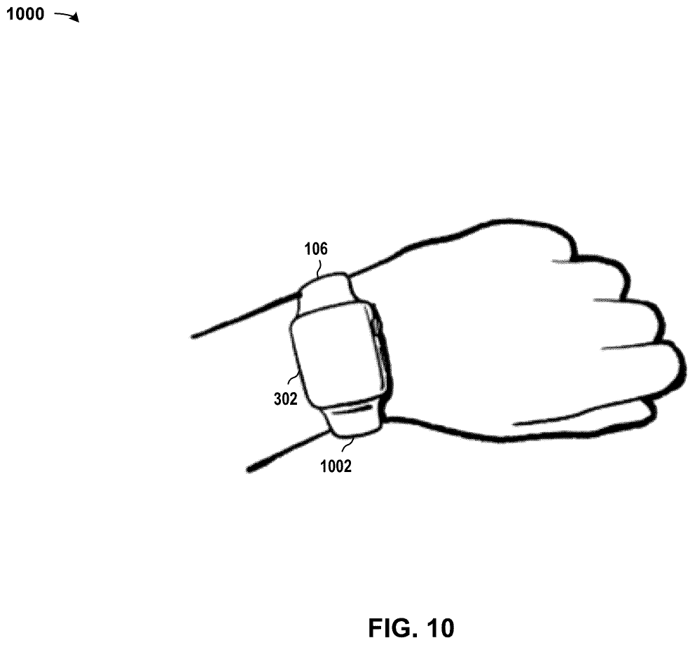

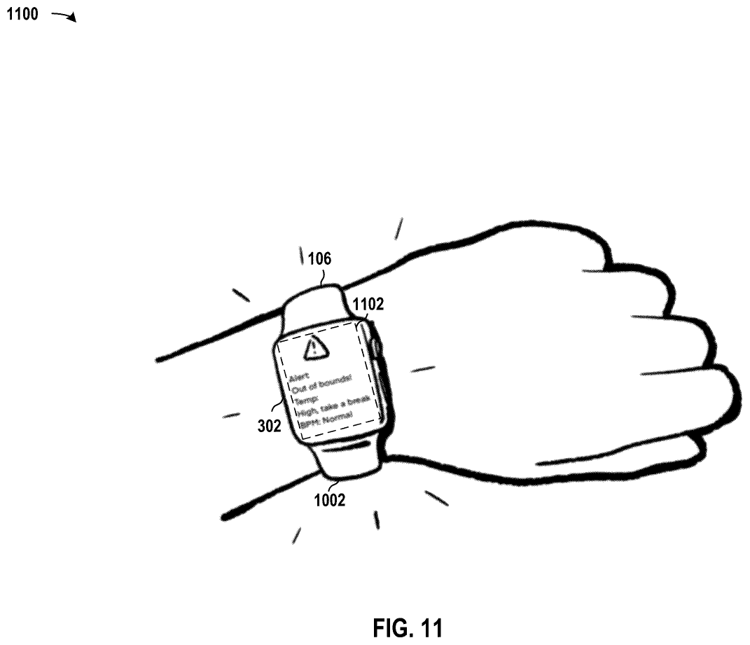

FIG. 10 is an example of the wearable device 106 of one of the workers 902-904 prior or before receiving the alert 124, as shown in FIG. 1. Because no alert is provided to the wearable device 106, the wearable device 106 does not notify the worker. FIG. 11 is an example of the wearable device 106 of one of the workers 902-904 after receiving the alert 124, which causes the wearable device to suggest to the user to take a break and the user is out of bounds, as shown at 1102. As shown in FIGS. 10-11, the wearable device 106 can include in some instances a band or strap 1002 and the case 302, which can include one or more components and/or elements of the wearable device 106 (e.g., see FIG. 3), and described herein. A portion of the case 302 can correspond to the display of wearable device 106, as shown in FIGS. 10-11. The wearable device 106 can be secured around a wrist of each of the workers 902-904, as shown in FIGS. 10-11.

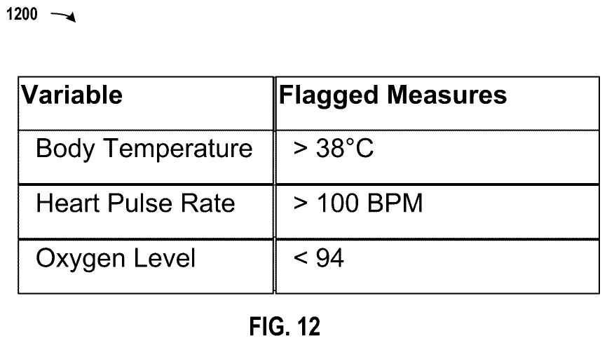

FIG. 12 is an example of a table 1200 identifying thresholds for use by the tool 118 for monitoring a safety and/or health of the user 104, as shown in FIG. 1. Thus, reference can be made to one or more examples of FIGS. 1-11 in the example of FIG. 12. The table 1200 includes a first column identifying variables, such as a body temperature, a heart (pulse) rate, and oxygen level. For each variable, a second column of the table 1200 identifies a respective threshold, such as a temperature threshold, heart rate threshold, and an oxygen level threshold. The tool 118 can use one of the thresholds to determine whether a health and/or well being of the user 104 is at risk. Thus, the tool 118 can evaluate each physiological or gas measurement (or recording) to a corresponding threshold to determine whether the measured/recording satisfies or does not satisfy a respective threshold or condition. For example, the health monitoring engine 120 can receive oxygen saturation readings from the wearable device 106 and compare each oxygen saturation reading to the oxygen level threshold to determine whether the user 104 is at risk for a health condition (e.g., hypoxemia). The oxygen saturation readings can be part of the physiological data 122, as shown in FIG. 1. If an oxygen saturation reading is above or equal to the oxygen level threshold, the health monitoring engine 120 can issue the alert 124, which can be provided to the wearable device 106 to notify the user 104, for example, of elevated oxygen saturation readings.

In view of the foregoing structural and functional features described above, an example method will be better appreciated with reference to FIGS. 4-5. While, for purposes of simplicity of explanation, the example methods of FIGS. 4-5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

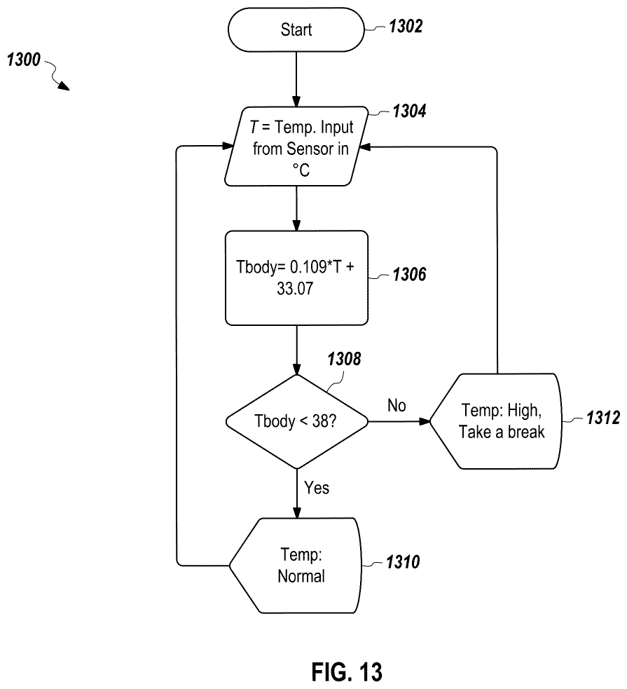

FIG. 13 is an example of a method 1300 for notifying the user 104 (e.g., a worker) using the wearable device 106 that the user 104 has an elevated body temperature. One or more steps of the method 1300 can be implemented by the health monitoring engine 120, as shown in FIG. 1. Thus, reference can be made to one or more examples of FIGS. 1-12 in the example of FIG. 13. The method 1300 can begin at 1302, for example, with the tool 118 calling or running the health monitoring engine 120. At 1304, the health monitoring engine 120 can receive a temperature measurement (recording) corresponding to a measured skin temperature of the user, which can be part of the physiological data 122, as shown in FIG. 1. The temperature measurement can be in Celsius. At 1306, the health monitoring engine 120 can determine a body temperature of the user. The health monitoring engine 120 can use the following expression to determine the body temperature of the user:

$${T}_{Body} = 0.109 * {T}_{Skin} + 3 3.07 ( °C . ) , \qquad ( 1 )$$

wherein Tₛₖᵢₙ is a skin body temperature of the user (e.g., as measured by a temperature sensor of the wearable device 106), and T_{Body} is the body temperature of the user.

At 1306, a determination is made by the health monitoring engine 120 as to whether the body temperature of the user is greater than or equal to a body temperature threshold. The method 1300 proceeds to step 1308 in response to determining that the body temperature of the user is not greater than or equal to the body temperature threshold, which causes the method 1300 to loop back to step 1302 to receive another temperature measurement for the user. The method 1300 proceeds to step 1310 in response to determining that the body temperature of the user is greater than or equal to the body temperature threshold. At 1312, the health monitoring engine 120 issues the alert 124, as shown in FIG. 1. The alert 124 can be provided to the wearable device 106 to notify the user 104 that the user's body temperature is “elevated” and suggest that the user take a break. An “elevated body temperature” refers to a body temperature of the user that exceeds the body temperature threshold and that can lead to heat stroke.

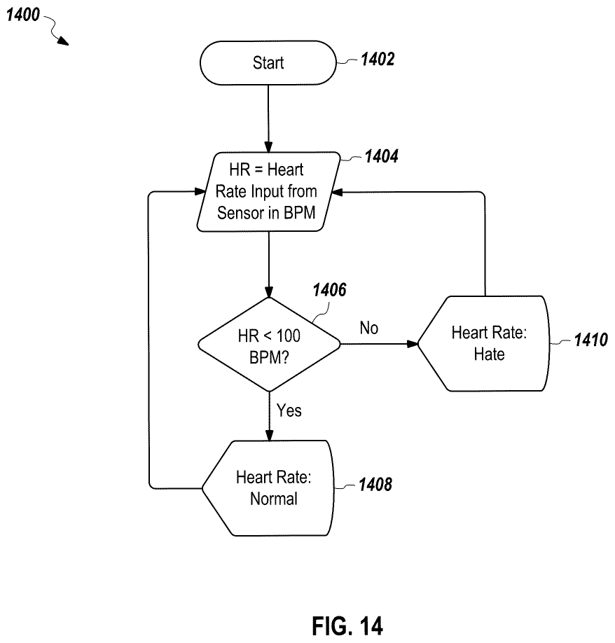

FIG. 14 is an example of a method 1400 for notifying the user 104 (e.g., a worker) using the wearable device 106 that the user 104 has an elevated heart rate. One or more steps of the method 1400 can be implemented by the health monitoring engine 120, as shown in FIG. 1. Thus, reference can be made to one or more examples of FIGS. 1-13 in the example of FIG. 14. The method 1400 can begin at 1402, for example, with the tool 118 calling or running the health monitoring engine 120. At 1404, the health monitoring engine 120 can receive a heart rate measurement of the user corresponding to a detected heart rate of the user, which can be part of the physiological data 122, as shown in FIG. 1. The heart rate measurement can be a derived heart rate that is calculated from data collected by a corresponding sensor of the wearable device 106, as disclosed herein. The heart rate measurement can be in beat per minute (BPM).

At 1406, a determination is made by the health monitoring engine 120 as to whether the heart rate measurement of the user is greater than or equal to a heart rate threshold. The method 1400 proceeds to step 1408 in response to determining that the heart rate measurement of the user is not greater than or equal to the heart rate threshold, which causes the method 1400 to loop back to step 1404 to receive another heart rate measurement for the user. The method 1400 proceeds to step 1410 in response to determining that the heart rate measurement of the user is greater than or equal to the heart rate threshold. At 1408, the health monitoring engine 120 issues the alert 124, as shown in FIG. 1. The alert 124 can be provided to the wearable device 106 to notify the user 104 that the user's heart rate is “elevated” and suggest that the user take a break. An “elevated heart rate” refers to a heart rate that exceeds the heart rate threshold of a user and that can lead to a heart condition (e.g., Tachycardia).

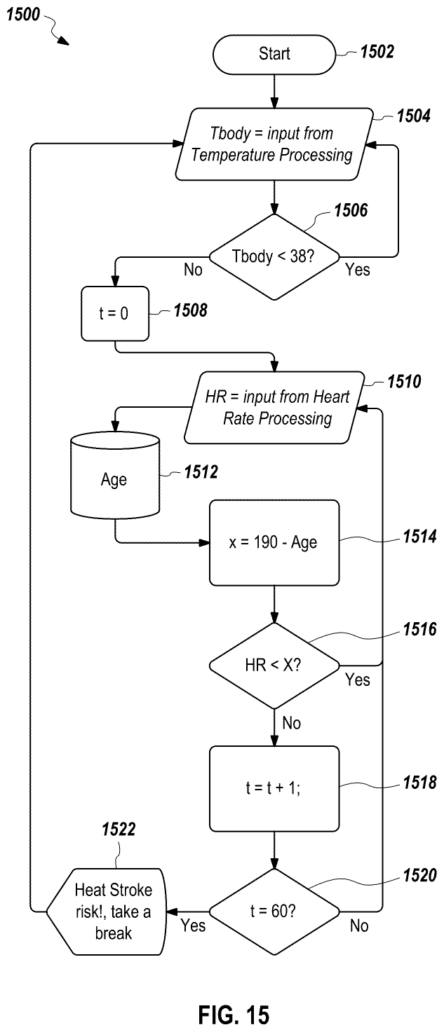

FIG. 15 is an example of a method 1500 for notifying the user 104 (e.g., a worker) using the wearable device 106 that the user 104 is at risk for heat stroke. One or more steps of the method 1500 can be implemented by the health monitoring engine 120, as shown in FIG. 1. Thus, reference can be made to one or more examples of FIGS. 1-14 in the example of FIG. 15. The method 1500 can begin at 1502, for example, with the tool 118 calling or running the health monitoring engine 120. At 1504, the health monitoring engine 120 can determine a body temperature of the user. In some examples, the health monitoring engine 120 can determine the body temperature in a same or similar manner as described herein with respect to step 1306, as shown in FIG. 13.

At 1506, a determination is made by the health monitoring engine 120 as to whether the body temperature of the user is greater than or equal to the body temperature threshold. The method 1500 can loop back to step 1504 in response to determining that the body temperature of the user is not greater than or equal to the heart rate threshold to receive another heart rate measurement for the user. The method 1500 proceeds to step 1508 in response to determining that the body temperature of the user is greater than or equal to the body temperature threshold. At step 1508, a timer can be initiated for predicting that the user is at risk for heat stroke.

At 1510, the health monitoring engine 120 can receive the heart rate measurement of the user corresponding to the detected heart rate of the user. At 1512, an age of the user can be received. For example, the age of the user can be obtained from work information, which can be stored in the memory 114, or on the wearable device 106 and received from the wearable device 106 by the health monitoring engine 120. At 1514, an expected heart rate measurement can be calculated for the user by subtracting the age of the user from 180. At 1516, a determination is made by the health monitoring engine 120 as to whether the received heart rate measurement is less than or equal to expected heart rate measurement. The method 1500 can loop back to step 1510 in response to determining that the received heart rate measurement is less than or equal to the expected heart rate measurement. The method 1500 can proceed to step 1518 in response to determining that the received heart rate measurement is not less than or equal to the expected heart rate measurement. At 1518, the timer can be incremented by one (e.g., one second). At 1520, a determination is made by the health monitoring engine 120 as to whether a timer value to which the timer has been incremented is equal to a time value, such as 60 seconds. The method 1500 loops back to 1510 in response to determining that the time does not equal the time value and step 1510 is repeated. In some examples, the method 1500 proceeds to step 1522. At 1522, the health monitoring engine 120 issues the alert 124, as shown in FIG. 1. The alert 124 can be provided to the wearable device 106 to notify the user 104 that the user's heat stroke is elevated, and that the user 104 should take a break. In some examples, the method 1500 can loop back to step 1504 in response to the alert being provided to the wearable device 106.

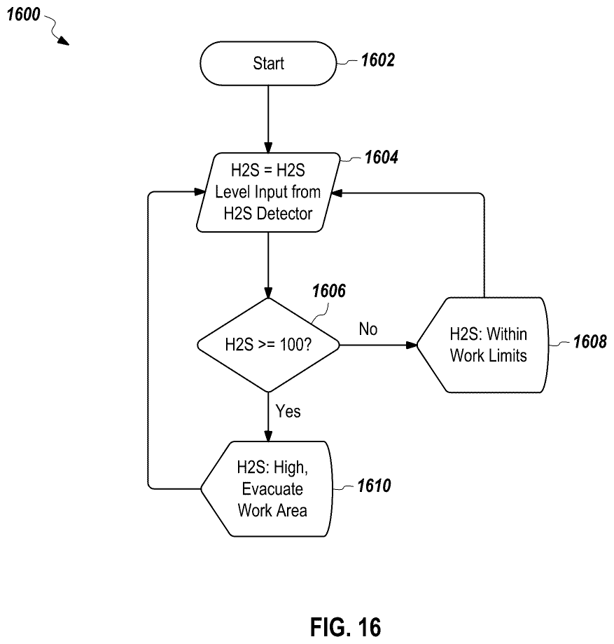

FIG. 16 is an example of a method 1600 for notifying the user 104 (e.g., a worker) using the wearable device 106 of an elevated concentration of H₂S gas, such as at the work area 102. One or more steps of the method 1600 can be implemented by the health monitoring engine 120, as shown in FIG. 1. Thus, reference can be made to one or more examples of FIGS. 1-15 in the example of FIG. 16. The method 1600 can begin at 1602, for example, with the tool 118 calling or running the health monitoring engine 120. At 1604, the health monitoring engine 120 can receive a concentration measurement of the H₂S gas, which can be part of the gas data 140, as shown in FIG. 1. At 1606, a determination is made by the health monitoring engine 120 as to whether the concentration measurement of the H₂S gas is greater than or equal to an H₂S gas threshold. The method 1600 proceeds to step 1608 in response to determining that the concentration measurement of the H₂S gas is not greater than or equal to the H₂S gas threshold, which causes the method 1600 to loop back to step 1604 to receive another concentration measurement of the H₂S gas from the gas data 140. The method 1600 proceeds to step 1608 in response to determining that the concentration measurement of the H₂S gas is greater than or equal to the H₂S gas threshold. At 1608, the health monitoring engine 120 issues the alert 124, as shown in FIG. 1. The alert 124 can be provided to the wearable device 106 to notify the user 104 that the work area 102 has an elevated level of a H₂S gas (e.g., that can be harmful to the user 104) and that the user should evacuate the work area 102 (or work area).

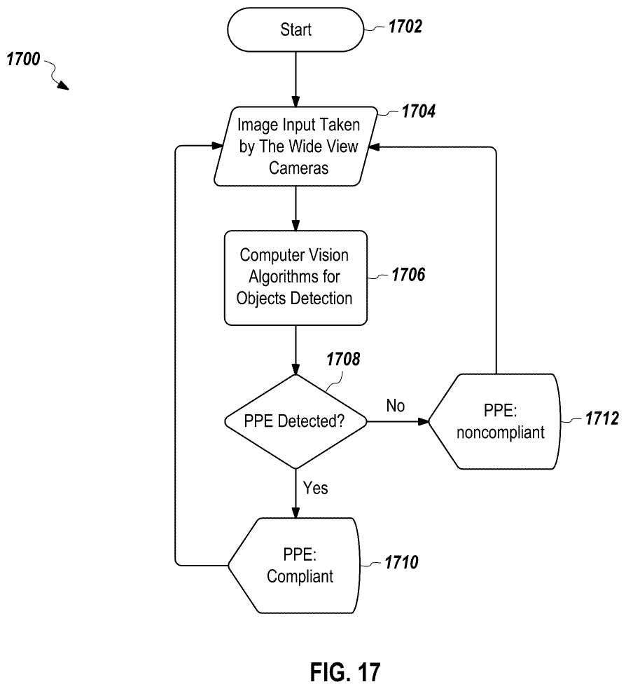

FIG. 17 is an example of a method 1700 for notifying the user 104 (e.g., a worker) using the wearable device 106 that the user is out of personal protective equipment (PPE) compliance. One or more steps of the method 1700 can be implemented by the compliance engine 126, as shown in FIG. 1. Thus, reference can be made to one or more examples of FIGS. 1-16 in the example of FIG. 17. The method 1700 can begin at 1702, for example, with the tool 118 calling or running the compliance engine 126. At 1704, the compliance engine 126 can receive one or more images which can be part of the image data 128, as shown in FIG. 1. At 1706, the compliance engine 126 can use a vision algorithm to detect one or more objects in the one or more images or determine whether the one or images contain a PPE object. At 1708, a determination is made by the compliance engine 126 to determine whether the detected object is a PPE object, or the one or more images contain the PPE object. The method 1700 can proceed to step 1710 in response to determining that the detected object is a PPE object, and loop back to step 1702 to analyze one or more additional images from the image data 128. The method 1700 can proceed to step 1712 in response to determining that the detected object is not a PPE object. At 1710, the compliance engine 126 can issue the alert 124, as shown in FIG. 1, and the method 1700 can loop back to step 1704. The alert 124 can be provided to the wearable device 106 to notify the user 104 that the user 104 is not PPE compliant.

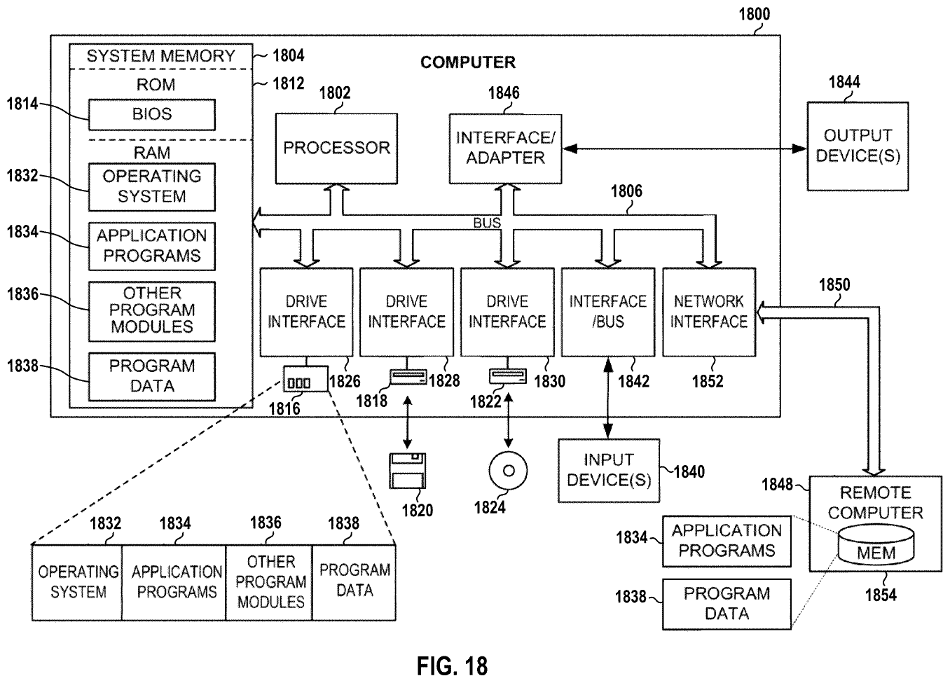

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 18. Thus, reference can be made to one or more examples of FIGS. 1-17 in the example of FIG. 18.

In this regard, FIG. 18 illustrates one example of a computer system 1800 that can be employed to execute one or more embodiments of the present disclosure. Computer system 1800 can be implemented on one or more general purpose networked computer systems, embedded computer systems, routers, switches, server devices, client devices, various intermediate devices/nodes, or standalone computer systems. Additionally, computer system 1800 can be implemented on various mobile clients such as, for example, a personal digital assistant (PDA), laptop computer, pager, and the like, provided it includes sufficient processing capabilities.

Computer system 1800 includes processing unit 1802, system memory 1804, and system bus 1806 that couples various system components, including the system memory 1804, to processing unit 1802. Dual microprocessors and other multi-processor architectures also can be used as processing unit 1802. System bus 1806 may be any of several types of bus structure including a memory bus or memory controller, a peripheral bus, and a local bus using any of a variety of bus architectures. System memory 1804 includes read only memory (ROM) 1810 and random access memory (RAM) 1812. A basic input/output system (BIOS) 1814 can reside in ROM 1812 containing the basic routines that help to transfer information among elements within computer system 1800.

Computer system 1800 can include a hard disk drive 1816, magnetic disk drive 1818, e.g., to read from or write to removable disk 1820, and an optical disk drive 1822, e.g., for reading CD-ROM disk 1824 or to read from or write to other optical media. Hard disk drive 1816, magnetic disk drive 1818, and optical disk drive 1822 are connected to system bus 1806 by a hard disk drive interface 1826, a magnetic disk drive interface 1828, and an optical drive interface 1830, respectively. The drives and associated computer-readable media provide nonvolatile storage of data, data structures, and computer-executable instructions for computer system 1800. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 1810, including operating system 1832, one or more application programs 1834, other program modules 1836, and program data 1838. In some examples, the application programs 1834 can include one or more modules (or block diagrams), or systems, as shown and disclosed herein. Thus, in some examples, the application programs 1834 can include the tool 118, as shown in FIG. 1.

A user may enter commands and information into computer system 1800 through one or more input devices 1840, such as a pointing device (e.g., a mouse, touch screen), keyboard, microphone, joystick, game pad, scanner, and the like. These and other input devices are often connected to processing unit 1802 through a corresponding port interface 1842 that is coupled to the system bus, but may be connected by other interfaces, such as a parallel port, serial port, or universal serial bus (USB). One or more output devices 1844 (e.g., display, a monitor, printer, projector, or other type of displaying device) is also connected to system bus 1806 via interface 1846, such as a video adapter.

Computer system 1800 may operate in a networked environment using logical connections to one or more remote computers, such as remote computer 1848. Remote computer 1848 may be a workstation, computer system, router, peer device, or other common network node, and typically includes many or all the elements described relative to computer system 1800. The logical connections, schematically indicated at 1850, can include a local area network (LAN) and a wide area network (WAN). When used in a LAN networking environment, computer system 1800 can be connected to the local network through a network interface or adapter 1852. When used in a WAN networking environment, computer system 1800 can include a modem, or can be connected to a communications server on the LAN. The modem, which may be internal or external, can be connected to system bus 1806 via an appropriate port interface. In a networked environment, application programs 1834 or program data 1838 depicted relative to computer system 1800, or portions thereof, may be stored in a remote memory storage device 1854.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

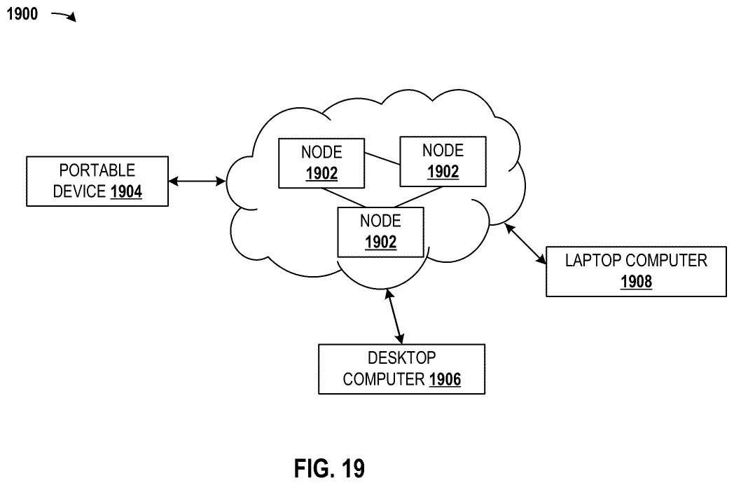

FIG. 19 is an example of a cloud computing environment 1900 that can be used for implementing one or more modules and/or systems in accordance with one or more examples, as disclosed herein. Thus, reference can be made to one or more examples of FIGS. 1-19 in the example of FIG. 19. As shown, cloud computing environment 1900 can include one or more cloud computing nodes 1902 with which local computing devices used by cloud consumers (or users), such as, for example, personal digital assistant (PDA), cellular, or portable device 1904, a desktop computer 1906, and/or a laptop computer 1908, may communicate. The computing nodes 1902 can communicate with one another. In some examples, the computing nodes 1902 can be grouped (not shown) physically or virtually, in one or more networks, such as Private, Community, Public, or Hybrid clouds, or a combination thereof. This allows the cloud computing environment 1900 to offer infrastructure, platforms and/or software as services for which a cloud consumer does not need to maintain resources on a local computing device. The devices 1904-1908, as shown in FIG. 19, are intended to be illustrative and that computing nodes 1902 and cloud computing environment 1900 can communicate with any type of computerized device over any type of network and/or network addressable connection (e.g., using a web browser). In some examples, the one or more computing nodes 1902 are used for implementing one or more examples disclosed herein relating to root-source identification. Thus, in some examples, the one or more computing nodes can be used to implement modules, platforms, and/or systems, as disclosed herein.

In some examples, the cloud computing environment 1900 can provide one or more functional abstraction layers. It is to be understood that the cloud computing environment 1900 need not provide all of the one or more functional abstraction layers (and corresponding functions and/or components), as disclosed herein. For example, the cloud computing environment 1900 can provide a hardware and software layer that can include hardware and software components. Examples of hardware components include mainframes; RISC (Reduced Instruction Set Computer) architecture based servers; servers; blade servers; storage devices; and networks and networking components. In some embodiments, software components include network application server software and database software.

In some examples, the cloud computing environment 1900 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 1900 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1900, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 1900 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 1900 can provide a workloads layer that provides examples of functionality for which the cloud computing environment 1900 may be utilized. Examples of workloads and functions which may be provided from this layer include mapping and navigation; software development and lifecycle management; virtual classroom education delivery; data analytics processing; and transaction processing. Various embodiments of the present disclosure can utilize the cloud computing environment 1900.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

What has been described above includes mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A system comprising:
a wearable device worn by a user in a geographical area that includes a work area and is configured to capture physiological measurements from the user and a location of the wearable device that is representative of a location of the user; and
a work area safety analysis tool to evaluate the captured physiological measurements and the location to assess potential health and/or safety risks to the user with respect to the work area.

2. The system of claim 1, wherein the wearable device is to receive gas measurements from a gas sensor located in the work area, and the work area safety analysis tool is to evaluate the gas measurements to assess the potential health and/or safety risks to the user with respect to the work area.

3. The system of claim 1, wherein the wearable device communicates with the gas sensor via Bluetooth to receive the gas measurements.

4. The system of claim 1, wherein the wearable device is configured as a Long-Term Evolution machine (LTE-M) type of device and communicates with the work area safety analysis tool over a network configured to support LTE-M.

5. The system of claim 4, wherein the work area safety analysis tool is implemented on a computing platform.

6. The system of claim 1, wherein the work area safety analysis tool is to communicate an alert based on the evaluation to notify the user that the health and/or safety is potentially at risk.

7. The system of claim 1, wherein the wearable device includes a display, and the display to display a notification indicating that the health and/or safety of the user is potentially at risk.

8. The system of claim 1, wherein the work area safety analysis tool is to:
evaluate the location of the wearable device relative to a geofence representative of a virtual perimeter of the work area to determine whether the user is outside of the work area; and
communicate an alert to the wearable device in response to determining that the user is outside of the work area, wherein a display of the wearable device is to display a notification that the user is outside of the work area based on the alert.

9. The system of claim 1, wherein the work area safety analysis tool is to:
evaluate the captured physiological measurements to determine whether the user is potentially at risk of heat stroke; and
communicate an alert to the wearable device in response to determining that the user is potentially at risk of heat stroke, wherein a display of the wearable device is to display a notification suggesting that the user take a break to reduce the risk of heat stroke based on the alert.

10. The system of claim 1, wherein
the wearable device is configured with one or more cameras to capture one or more images of the user and communicate over a network the one or more images to the work area safety tool, and
the work area safety analysis tool is to evaluate the one or more images of the user to determine whether the user is personal protective equipment compliant.

11. The system of claim 1, wherein the wearable device is a wristband device that includes a body or case comprising one or more components of the wearable device for capturing the physiological measurements and the location of the wearable device, and a strap securing the wearable device to a wrist of the user.

12. A system comprising:
a wearable device configurable to be worn by a worker in an industrial or construction work area, the wearable device comprising:
cameras to capture one or more images of the user;
physiological sensors to capture physiological measurements of the user;
a location component to determine a location of the wearable device that is representative of a location of the user;
a communication component to transmit over a wireless network the physiological measurements, and the location of the wearable device to a work area safety analysis tool on a remote computing platform;
memory to store machine-readable instructions; and
one or more processors to access the memory and execute the machine-readable instructions to receive an alert indicating that a health and/or safety of the user is potentially at risk, wherein the alert is generated by the work area safety analysis tool in response to determining that a health and/or safety of the user is potentially at risk with respect to the industrial or construction work area based on the capture physiological measurements and the location of the wearable device.

13. The system of claim 12, wherein the wearable device further comprises one of a display, a vibrator and a microphone, and the machine readable instructions are configured to control one or more of the display, the vibrator and the microphone to notify the user that the health and/or safety of the user is potentially at risk.

14. The system of claim 12, wherein the wearable device is to receive using Bluetooth gas measurements from a gas sensor located in the industrial or construction work area, and the work area safety analysis tool is to evaluate the gas measurements to assess the potential healthy and/or safety risks to the user with respect to the industrial or construction work area.

15. The system of claim 13, wherein,
the location component includes a GNSS receiver,
the communication component includes an embedded subscriber identity module,
the cameras include first, second, and third wide view cameras,
the sensors include a temperature sensor to provide temperature measurements of the user and a pulse oximeter sensor to provide oxygen level and heart rate measurements of the user, the physiological measurements include temperature measurements, the oxygen level and heart rate measurements, and
wearable device is a wristband type of device.
